(19) United States
(12) Patent Application Publication
(10) Pub. No.: US 2026/0213473 A1
(43) Pub. Date: Jul. 23, 2026

(54) SEIZURE ASSEMBLY AND HYBRID FIBER-COAXIAL NETWORK DEVICE INCLUDING THE SAME

(71) Applicant: Global Technology Inc., Ningbo (CN)

(72) Inventors: Hao Jin, Ningbo (CN); Sheng Su, Ningbo (CN); Fan Yang, Ningbo (CN); Qikun Huang, Ningbo (CN)

(21) Appl. No.: 19/290,867

(22) Filed: Aug. 5, 2025

(30) Foreign Application Priority Data
Jan. 17, 2025 (CN) 202510080360.5

(51) Int. Cl. H01R 24/50; H01R 103/00

(52) U.S. Cl. CPC H01R 24/50; H01R 2103/00

(57) ABSTRACT

A seizure assembly for a coaxial cable includes a conductor with a leaf spring receptacle portion to provide a coaxial cable connection inside an HFC network device, such as an HFC node or amplifier. A seizure assembly for mounting circuit boards further includes a mounting portion for the circuit board formed from the same piece of metal as the leaf spring receptacle portion.

### CROSS-REFERENCE TO RELATED APPLICATIONS

This non-provisional application claims priority under 35 U.S.C. § 119(a) on Patent Application No(s). 202510080360.5 filed in China on January 17th, 2025, the entire contents of which are hereby incorporated by reference.

### BACKGROUND

### Technical Field

The present disclosure relates to a seizure assembly and hybrid fiber-coaxial network device including the same.

### Related Art

Hybrid fiber-coaxial (HFC) networks are used to provide high bandwidth communication between a headend/hub and end users such as homes and businesses. Such HFC networks are often used, for example, to provide cable television (CATV) and internet services to the end users. An HFC network architecture generally includes optical fiber for carrying optical signals (e.g., from the headend/hub), coaxial cables for carrying RF signals (e.g., to the end users), and HFC network devices, such as HFC nodes, amplifiers, and taps, that connect to the optical fiber and/or coaxial cables. The Data Over Cable Service Interface Specification (DOCSIS) has been adopted to standardize continued improvements of existing HFC networks in order to provide additional bandwidth for enhanced TV and Internet services, and there may be a need to upgrade the HFC network infrastructure to meet increasing bandwidth demands, for example, when moving from DOCSIS 3.1 to DOCSIS 4.0.

Connections between HFC network devices and coaxial cables should allow a cable to be relatively easily connected while providing the desired RF performance at the RF frequencies of the HFC network. An HFC network device, such as an HFC node or amplifier, may include a coaxial cable port where the coaxial cable is coupled to a cable center conductor pin (also referred to as the “stinger”) electrically coupled inside the HFC network device using a coaxial cable seizure assembly. The length and contact of that cable center conductor pin may affect the RF connection and performance. As such, the connections between the HFC network devices and the coaxial cables may need to be upgraded as the network moves to a different DOCSIS standard with higher bandwidths and RF frequencies.

### SUMMARY

According to one embodiment of the present disclosure, a seizure assembly for a coaxial cable is configured to be coupled to the coaxial cable in a hybrid fiber-coaxial (HFC) network device. The seizure assembly includes a circuit board, an insulator portion, a conductor, and a coil. The insulator portion is coupled to the circuit board. The insulator portion defines a spring receptacle passageway which is proximate to a pin-receiving opening for a center conductor pin of the coaxial cable at a side of the insulator portion. The conductor includes a leaf spring receptacle portion and a mounting portion for the circuit board which are coupled to each other. The leaf spring receptacle portion is disposed in the spring receptacle passageway. The leaf spring receptacle portion is configured to receive the center conductor pin passing through the pin-receiving opening. The mounting portion is electrically coupled to the circuit board. The coil is electrically coupled to the circuit board.

According to another embodiment of the present disclosure, the HFC network device includes a housing, a seizure assembly for a coaxial cable, and a coaxial RF connector. The housing includes a coaxial cable port configured to be coupled to the coaxial cable external to the housing. The seizure assembly is disposed in the housing. A center conductor pin of the coaxial cable extends through the coaxial cable port and extends into the seizure assembly. The seizure assembly includes a circuit board, an insulator portion, a conductor, a coil, and a pin. The insulator portion is coupled to the circuit board. The insulator portion defines a spring receptacle passageway which is proximate to a pin-receiving opening for the center conductor pin of the coaxial cable at a side of the insulator portion. The conductor includes a leaf spring receptacle portion and a mounting portion for the circuit board which are coupled to each other. The leaf spring receptacle portion is disposed in the spring receptacle passageway. The leaf spring receptacle portion is configured to receive the center conductor pin passing through the pin-receiving opening. The mounting portion is electrically coupled to the circuit board. The coil is electrically coupled to the circuit board. The pin extends from the circuit board and is electrically coupled to the conductor through the circuit board. The coaxial RF connector is electrically coupled to the pin.

### BRIEF DESCRIPTION OF THE DRAWINGS

The present disclosure will become better understood from the detailed description given hereinbelow and the accompanying drawings which are given by way of illustration only and thus are not intended to limit the present disclosure and wherein:

FIG. 1 is a side view of a conductor for use in a seizure assembly for a coaxial cable according to an embodiment of the present disclosure;

FIG. 2 is a side perspective view of a conductor for use in a seizure assembly for a coaxial cable according to another embodiment of the present disclosure;

FIG. 3A is a front perspective view of the seizure assembly mounted with a circuit board and including the conductor shown in FIG. 2;

FIG. 3B is a back perspective view of the seizure assembly mounted with a circuit board and including the conductor shown in FIG. 2;

FIG. 4A is a front view of the seizure assembly mounted with the circuit board shown in FIGS. 3A and 3B;

FIG. 4B is a cross-sectional view taken along line B-B in FIG. 4A;

FIG. 4C is a cross-sectional view taken along line C-C in FIG. 4A;

FIGS. 5A to 5D are perspective views of seizure assemblies mounted with a circuit board according to different embodiments of the present disclosure;

FIG. 6A is a hybrid fiber-coaxial (HFC) network amplifier including a seizure assembly for a coaxial cable according to an embodiment of the present disclosure;

FIG. 6B is a housing portion of the HFC network amplifier shown in FIG. 6A including recessed regions for receiving seizure assemblies according to an embodiment of the present disclosure;

FIG. 7A is a front perspective view of a seizure assembly mounted with a circuit board according to another embodiment of the present disclosure;

FIG. 7B is an exploded view of the seizure assembly shown in FIG. 7A;

FIG. 7C is an exploded view of the seizure assembly shown in FIG. 7B;

FIG. 7D is a partially enlarged view of a hybrid fiber-coaxial network device according to another embodiment of the present disclosure;

FIG. 8 shows a simulation data obtained from RF simulation performed on the seizure assembly in FIG. 7A and a conventional seizure assembly; and

FIG. 9 is a side view of a seizure assembly according to still another embodiment of the present disclosure.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawings.

An embodiment of the present disclosure relates to a seizure assembly using a one-piece conductor, such as the seizure assembly described in U.S. Patent Application No. 18/223,801, filed on July 19th, 2023, entitled “COAXIAL CABLE SEIZURE ASSEMBLY WITH STAMPED CONDUCTOR FOR USE IN A HYBRID FIBER-COAXIAL (HFC) NETWORK DEVICE,” the entire contents of which are incorporated herein by reference. However, in a case in which high current in accordance with the CATV DOCSIS 4.0 standard is applied, the inventors have discovered that HFC network devices employing such seizure assembly may encounter issues in achieving the desired RF performance. In particular, this issue becomes more significant when a high current of 15 amperes (A) or more is applied.

A seizure assembly for a coaxial cable according to embodiments of the present disclosure includes a conductor with a leaf spring receptacle portion to provide a coaxial cable connection inside an HFC network device, such as an HFC node or amplifier. The conductor is stamped from a single piece of metal and is disposed in an insulator portion. The insulator portion may be disposed inside a housing of the HFC network device which is proximate to a coaxial cable port such that the leaf spring receptacle portion is aligned with and receives a center conductor pin of a coaxial cable coupled to the coaxial cable port. In one embodiment, the seizure assembly includes a conductor with the leaf spring portion and a pin portion configured to mate with a coaxial RF connector (e.g., a G-type connector) inside the housing. In another embodiment, a seizure assembly mounted with a circuit board (e.g. a printed circuit board (PCB)) includes a conductor with the leaf spring portion and a mounting portion for the circuit board formed from the same piece of metal as the leaf spring receptacle portion. The mounting portion is mounted to and electrically coupled to the circuit board such that the circuit board electrically couples the conductor to a pin that is coupled to the circuit board and configured to mate with a coaxial RF connector (e.g., a G-type connector) inside the housing.

The seizure assembly including a conductor with a leaf spring receptacle portion according to embodiments of the present disclosure allows a relatively simple and consistent connection with the center conductor pin and is capable of providing the desired RF performance. The conductor is also easier to be fabricated, as compared to the set-screw and spring-loaded seizure assemblies and other one-piece conductors. Further, by disposing a coil onto the seizure assembly, an excellent return loss performance, a high current flow, and high-bandwidth transmission can be achieved.

Some or all of the technical features disclosed in one or more embodiments of the present disclosure may be combined to achieve corresponding effects.

The term “couple” or “coupled to” refers to any connection, link, or the like. Unless otherwise specified, devices that “couple” or “are coupled to” each other do not need to be directly connected to each other and may be separated by intervening objects.

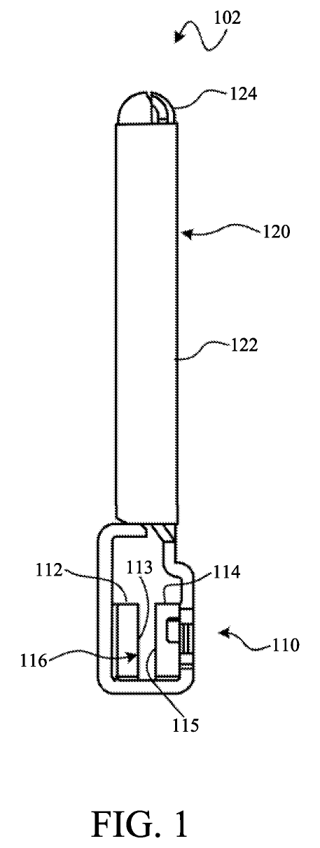

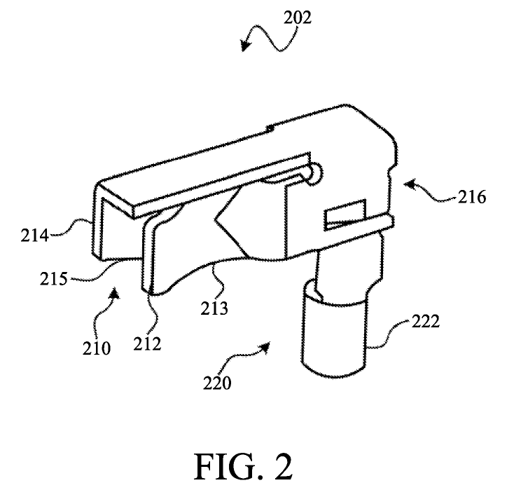

FIG. 1 is a side view of a conductor 102 for use in a seizure assembly for a coaxial cable according to an embodiment of the present disclosure, and FIG. 2 is a side perspective view of a conductor 202 for use in a seizure assembly for a coaxial cable according to another embodiment of the present disclosure. In one embodiment, referring to FIGS. 1 and 2, FIGS. 1 and 2 show electrical conductors 102, 202 used with the seizure assemblies according to the present disclosure. In one embodiment, both of the conductors 102, 202 respectively include leaf spring receptacle portions 110, 210 having similar designs, and both of the conductors 102, 202 may be stamped from a single piece of metal. In one embodiment, the conductors 102, 202 may be stamped from a high conductive copper of 0.30 mm, using progressive die tooling. In one embodiment, the high conductive copper may provide high strength, good conductivity (both heat and electrical), and good elastic force.

In one embodiment, the leaf spring receptacle portions 110, 210 may include leaf spring members 112, 114, 212, 214. In one embodiment, the leaf spring members 112, 114, 212, 214 may have rounded portions 113, 115, 213, 215. In one embodiment, the rounded portions 113, 115, 213, 215 may define center pin receiving passageways. In one embodiment, the rounded portions 113, 115, 213, 215 may be spaced apart from one another by a spacing that is less than a diameter of a center conductor pin of the coaxial cable (not shown in FIGS. 1 and 2) such that the center conductor pin is engaged with the rounded portions 113, 115, 213, 215 of the leaf spring members 112, 114, 212, 214 through a friction fit when being inserted in the center pin receiving passageway. In one embodiment, the pairs of leaf spring members 112, 114, 212, 214 may be biased against the center conductor pin to fasten the center conductor pin, and may provide an electrical connection between the rounded portions 113, 115, 213, 215 of the pairs of the leaf spring members 112, 114, 212, 214 and the center conductor pin. In one embodiment, the contact provided by the pairs of the leaf spring members 112, 114, 212, 214 may have a box shape to increase the cross-sectional area allowing for higher current carrying capability. In one embodiment, the center pin receiving passageway may also be open at back ends 116, 216 of the leaf spring receptacle portions 110, 210 to allow a longer center conductor pin to be received in the leaf spring receptacle portions 110, 210.

In one embodiment, the conductor 102 shown in FIG. 1 may further include pin portion 120. In one embodiment, the pin portion 120 and the leaf spring receptacle portion 110 may be formed form the same piece of metal. In one embodiment, the pin portion 120 may be configured to be engaged with a coaxial RF connector, such as a G-type connector, located in an HFC network device, as will be described in greater detail below. In one embodiment, the pin portion 120 may include an elongated cylindrical body 122 and a rounded tip 124, but other shapes and configurations are contemplated and within the scope of the present disclosure.

In one embodiment, the conductor 202 shown in FIG. 2 may further include a mounting portion 220 for a circuit board. In one embodiment, the mounting portion 220 and the leaf spring receptacle portion 210 may be formed form the same piece of metal. In one embodiment, the mounting portion 220 may be configured to be mounted with and electrically coupled to the circuit board, as will be described in greater detail below. In one embodiment, referring to FIG. 2, the mounting portion 220 may include a cylindrical body 222 configured to be received, for example, in a through hole of the circuit board, but other shapes and configurations are contemplated and within the scope of the present disclosure.

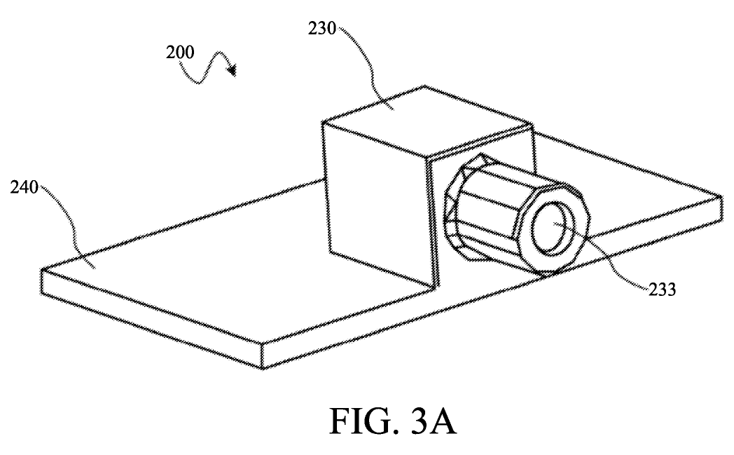

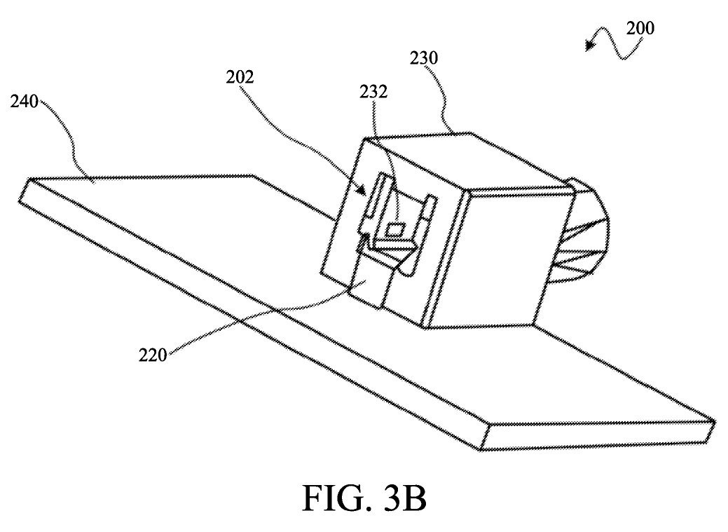

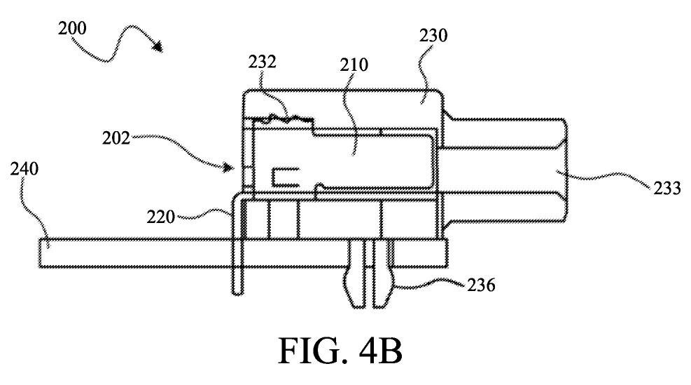

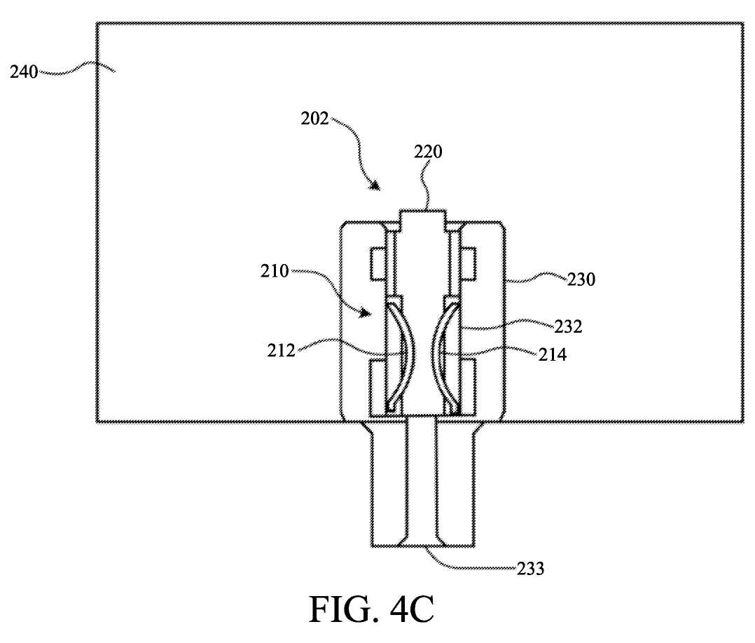

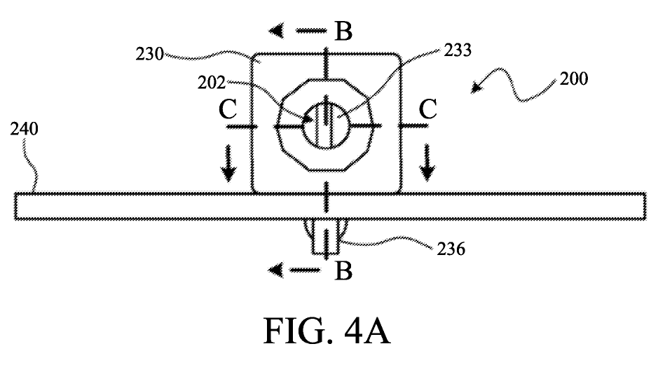

FIG. 3A is a front perspective view of a seizure assembly 200 mounted with a circuit board 240 and including the conductor 202 shown in FIG. 2, FIG. 3B is a back perspective view of the seizure assembly 200 mounted with the circuit board 240 and including the conductor shown 202 in FIG. 2, FIG. 4A is a front view of the seizure assembly 200 mounted with the circuit board 240 shown in FIGS. 3A and 3B, FIG. 4B is a cross-sectional view taken along line B-B in FIG. 4A, and FIG. 4C is a cross-sectional view taken along line C-C in FIG. 4A.

In one embodiment, referring to FIGS. 3A, 3B and 4A to 4C, the seizure assembly 200 mounted with the circuit board 240 and including the conductor 202 shown in FIG. 2 is described. In one embodiment, in the seizure assembly 200 mounted with the circuit board 240, the conductor 202 may be disposed in an insulator portion 230. In one embodiment, the insulator portion 230 may be mounted to the circuit board 240, for example, through a mounting member 236 (see FIG. 4B). In one embodiment, the mounting portion 220 of the conductor 202 may be configured to be mounted with and electrically coupled to the circuit board 240, which may provide a connection to a connector in an HFC network device, as will be described in greater detail below.

In one embodiment, referring to FIGS. 4A to 4C, the insulator portion 230 may include a spring receptacle passageway 232. In one embodiment, the spring receptacle passageway 232 may extend to a pin-receiving opening 233 for a center conductor pin of the coaxial cable at a side of the insulator portion 230. In one embodiment, the leaf spring receptacle portion 210 may be disposed in the spring receptacle passageway 232 such that a center conductor pin (not shown) passing through the pin-receiving opening 233 will be engaged between the pair of leaf spring members 212, 214 of the leaf spring receptacle portion 210 (see FIG. 4C). In one embodiment, the spring receptacle passageway 232 may also be open at a back side (e.g., as shown in FIG. 4B) to accommodate a longer center conductor pin that may extend through the leaf spring receptacle portion 210.

In one embodiment, the conductor 202 may be sandwiched between two pieces of plastic plates forming the insulator portion 230 and is fixed in the insulator portion 230 such that there is no movement of the conductor 102 relative to the insulator portion 230 except the movement of the leaf spring members for receiving the center conductor pin. In one embodiment, the insulator portion 230 may be made of a dielectric material, such as a plastic material.

In the embodiment of the seizure assembly 200, the mounting portion 220 may extend from the insulator portion 230 to the circuit board 240 and may be electrically coupled to a conductive path on the circuit board 240. In one embodiment, the conductor 202 of the seizure assembly 200 may be electrically coupled to a pin (not shown in FIGS. 4A to 4C) mounted to the circuit board 240 through the circuit board 240, and configured to mate with a coaxial RF connector, such as a G-type connector, in a housing of an HFC network device.

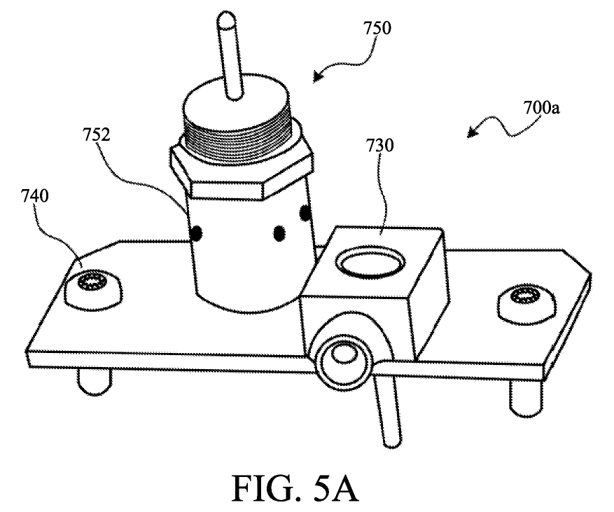

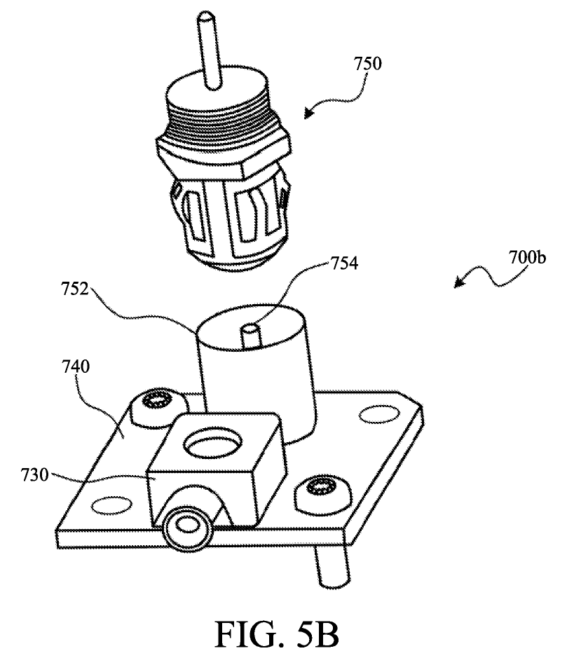

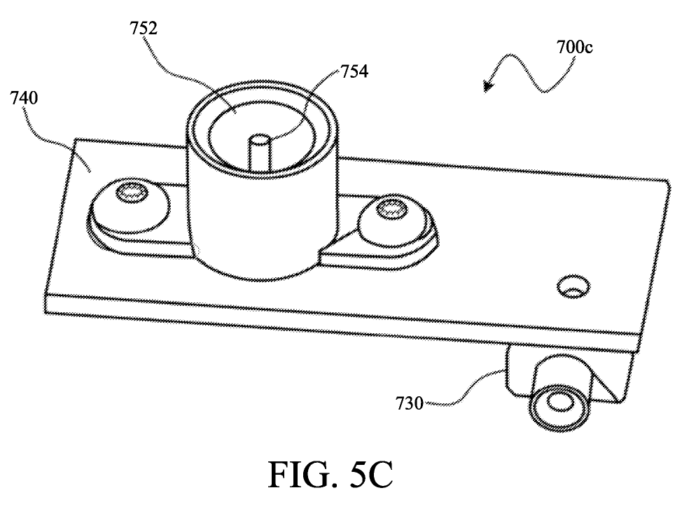

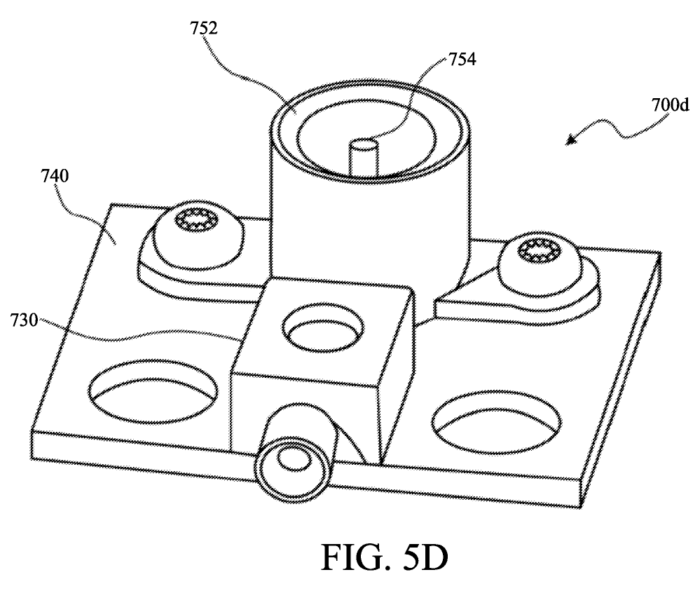

FIGS. 5A to 5D are perspective views of seizure assemblies 700a, 700b, 700c, 700d mounted with a circuit board 740 according to different embodiments of the present disclosure. In one embodiment, referring to FIGS. 5A to 5D, different embodiments of seizure assemblies 700a, 700b, 700c, 700d for mounting circuit boards and configured to be coupled to a G-type connector 750 are shown. In one embodiment, an insulator portion 730 having a conductor (not shown in FIGS. 5A to 5D) may be coupled to the circuit board 740, a coaxial RF connector receptacle 752 with a pin 754 may also be mounted to the circuit board 740, and the pin 754 is electrically coupled to the conductor inside the insulator portion 730 through a conductive path on the circuit board 740. In one embodiment, as shown in FIGS. 5A, 5B and 5D, the coaxial RF connector receptacle 752 and the pin 754 may be coupled to the same side of the circuit board 740 as the insulator portion 730 including the conductor, or may be coupled to an opposite side of the circuit board 740, as shown in FIG. 5C.

In the embodiments of seizure assemblies 700a, 700b, 700c, 700d for mounting circuit boards, the pin (e.g., the pin 754 mounted to the circuit board 740) may be configured to be coupled to a coaxial RF connector, such as a G-type connector or an F-type connector, inside a HFC network device. In one embodiment, the coaxial RF connector may include an inner conductive portion and a hole that receives the pin such that the pin is electrically coupled to the inner conductive portion. In one embodiment, the coaxial RF connector may further include an outer mating portion. In one embodiment, the outer mating portion may be received in the connector receptacle 752 of the seizure assemblies 700a, 700b, 700c, 700d for mounting circuit boards. In one implementation, the coaxial RF connector may have a large outer diameter (e.g., at least 10 mm).

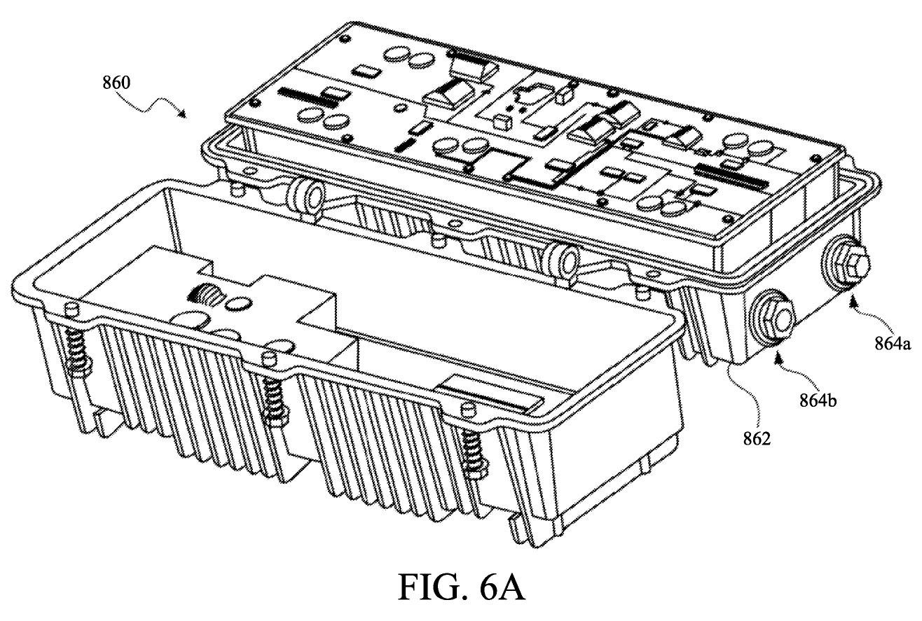

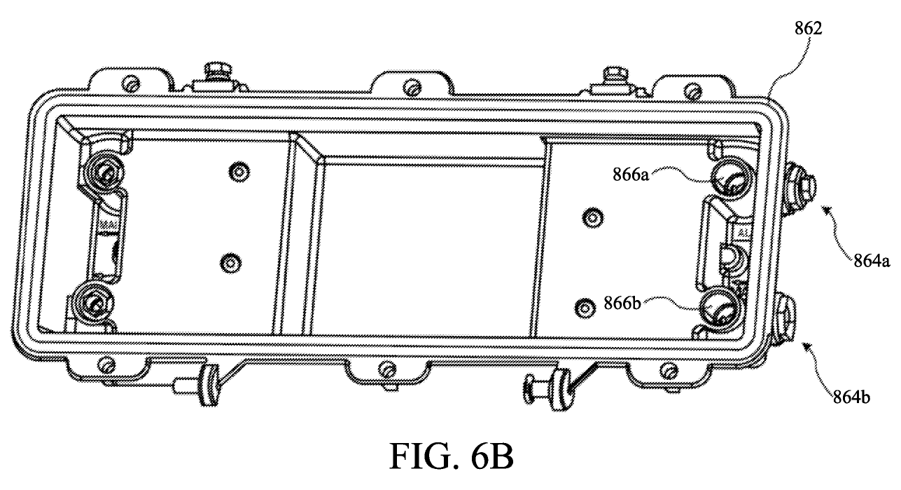

FIG. 6A is a hybrid fiber-coaxial (HFC) network amplifier 860 including a seizure assembly for a coaxial cable according to an embodiment of the present disclosure, and FIG. 6B is a housing portion of the HFC network amplifier 860 shown in FIG. 6A including recessed regions 866a, 866b for receiving seizure assemblies according to an embodiment of the present disclosure. In one embodiment, referring to FIGS. 6A and 6B, the seizure assembly may be used in an HFC amplifier 860 to provide a coaxial cable connection to cables outside the HFC amplifier 860. In one embodiment, HFC network amplifier 860 may include an amplifier housing 862 having coaxial cable connector ports 864a, 864b so as to be coupled to coaxial cables. In one embodiment, referring to FIG. 6B, the amplifier housing 862 may include recessed regions 866a, 866b. In one embodiment, the recessed regions 866a, 866b may be disposed inside the housing 862 which is proximate to the respective coaxial cable connector ports 864a, 864b so as to receive seizure assemblies, such as the seizure assembly 200. In one embodiment, the coaxial RF connector, such as the G-type connector, may be received in a hole of the connector receptacle 752 and engaged with the pin 754 so as to be electrically coupled to the pin 754.

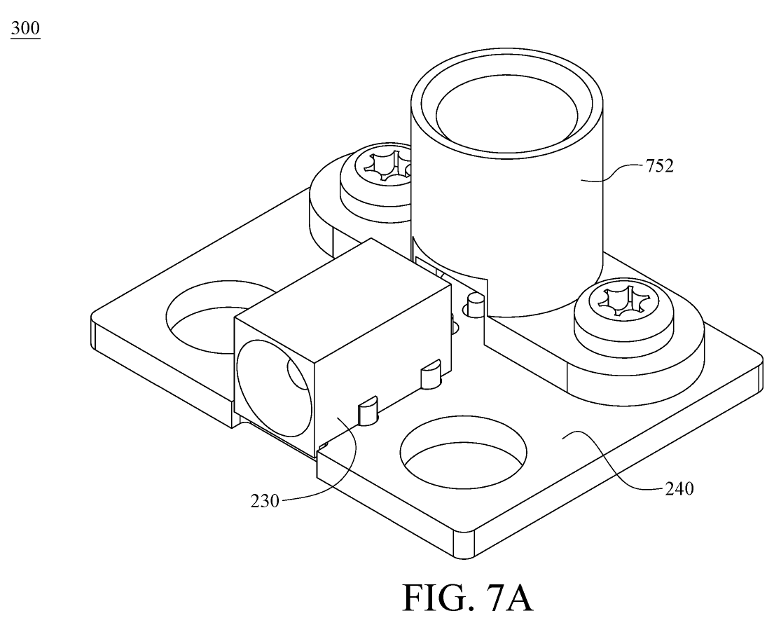

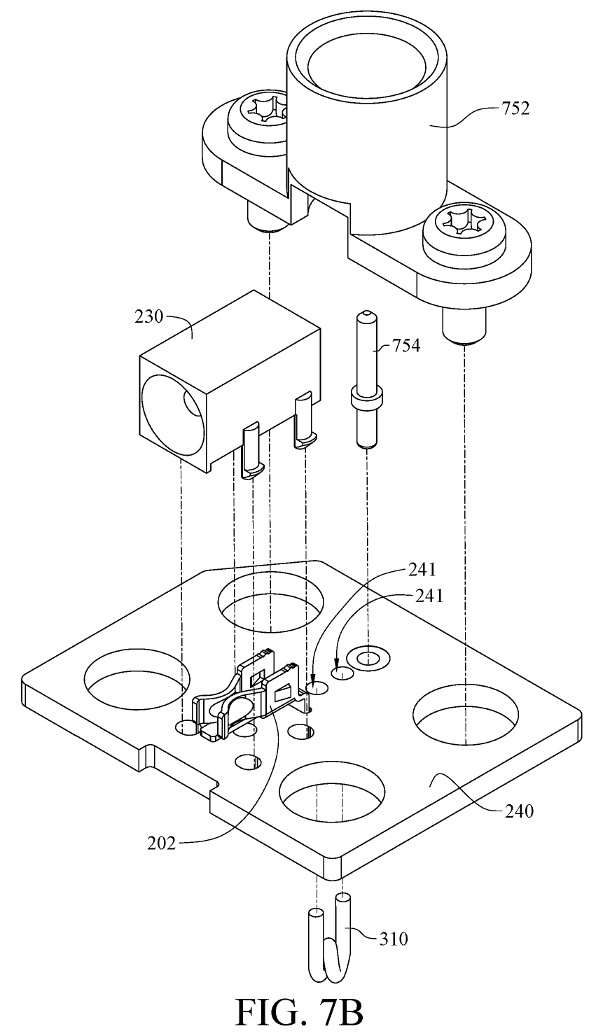

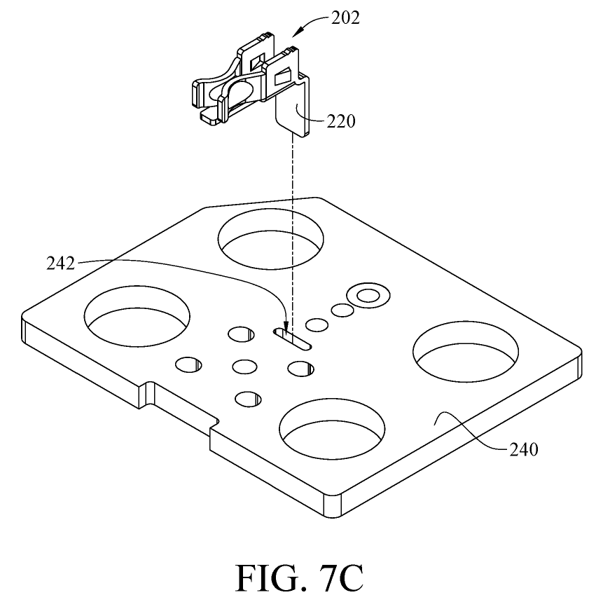

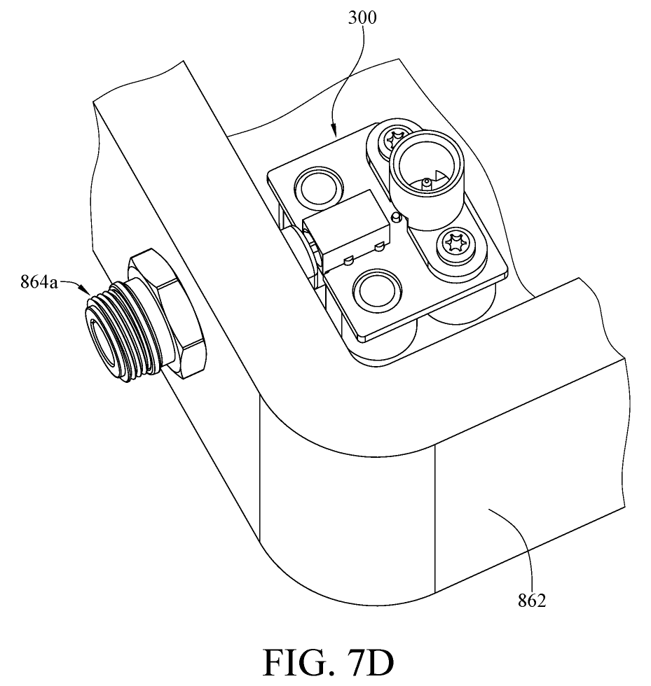

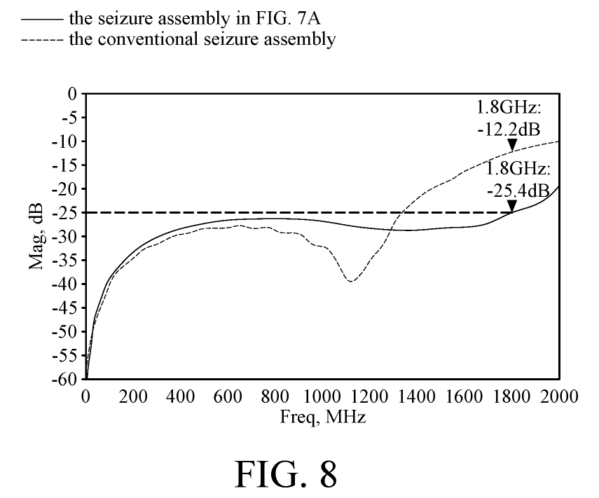

FIG. 7A is a front perspective view of a seizure assembly 300 mounted with the circuit board 240 according to another embodiment of the present disclosure, FIG. 7B is an exploded view of the seizure assembly 300 shown in FIG. 7A, and FIG. 7C is an exploded view of the seizure assembly 300 shown in FIG. 7B. In one embodiment, FIG. 7A shows a seizure assembly 300 for mounting circuit boards and including the conductor 202 shown in FIG. 2. In one embodiment, in the seizure assembly 300, the relationship among the conductor 202, the insulator portion 230, and the circuit board 240 may be realized by referring to the descriptions related to FIGS. 3A to 4C or FIG. 5D. A more detailed description of the differences between the seizure assembly 200 and the seizure assembly 300 is provided below.

In one embodiment, the seizure assembly 300 may further include a coil 310, and the coil 310 may be electrically coupled to the circuit board 240. In one embodiment, the coil 310 may be coupled to the routing on the surface of the circuit board 240 or inside the circuit board 240. In one embodiment, two opposite ends of the coil 310 may be disposed into two through holes 241 formed by the circuit board 240, respectively. In one embodiment, the mounting portion 220 of the conductor 202 may extend into a through hole 242 formed by the circuit board 240.

In one embodiment, the coil 310 may be electrically coupled to the conductor 202. In one embodiment, the coil 310 may be electrically coupled to the pin 754. In one embodiment, the mounting portion 220 may be electrically coupled to the routing of the circuit board 240. In one embodiment, the mounting portion 220 may be electrically coupled to one end of the coil 310 through the routing, and another end of the coil 310 may be electrically coupled to the pin 754 through the routing. In one embodiment, the conductor 202 and the coil 310 may be mounted on opposite sides of the circuit board 240. In one embodiment, the coil 310 may be a solenoidal coil formed by winding a wire. In one embodiment, the routing of the circuit board 240 may extend to the edges of, or even along the inner surfaces of, the through holes 241 and 242 so as to facilitate the electrical coupling of the coil 310 to the conductor 202 and the pin 754 through the routing. In one embodiment, the coil 310 may be an air-core coil in order to avoid magnetic saturation, thereby avoiding the RF performance from being reduced. Herein, the term “air-core coil” refers to a coil without any magnetic core disposed therethrough.

FIG. 7D is a partially enlarged view of a hybrid fiber-coaxial network device according to another embodiment of the present disclosure. In one embodiment, the seizure assembly 300 configured to be coupled to the coaxial cable in a hybrid fiber-coaxial (HFC) network device may be disposed in the housing. In one embodiment, the seizure assembly 300 may be proximate to the corresponding coaxial cable connector port 864a so that the center conductor pin of the coaxial cable may extend through the coaxial cable port and extends into the seizure assembly 300.

By disposing a wound coil onto the circuit board 240, flexible current level adaptability and optimized RF transmission performance can be achieved. The number of turns of the coil 310 can improve the RF performance of the connector for high-bandwidth transmission. In addition, the overcurrent capability can be enhanced by adjusting the thickness of the coil 310. Further, the operation is simple and on-site hardware upgrades may be supported.

FIG. 8 shows a simulation data obtained from RF simulation performed on the seizure assembly 300 in FIG. 7A and a conventional seizure assembly. The hybrid fiber-coaxial network device employing the conventional seizure assembly exhibits poor return loss performance (e.g., a return loss of -12.2 dB at 1.8 GHz). In contrast, the hybrid fiber-coaxial network device including the seizure assembly 300 as shown in FIG. 7A achieves improved impedance matching and exhibits excellent return loss performance (e.g., a return loss of -25.4 dB at 1.8 GHz).

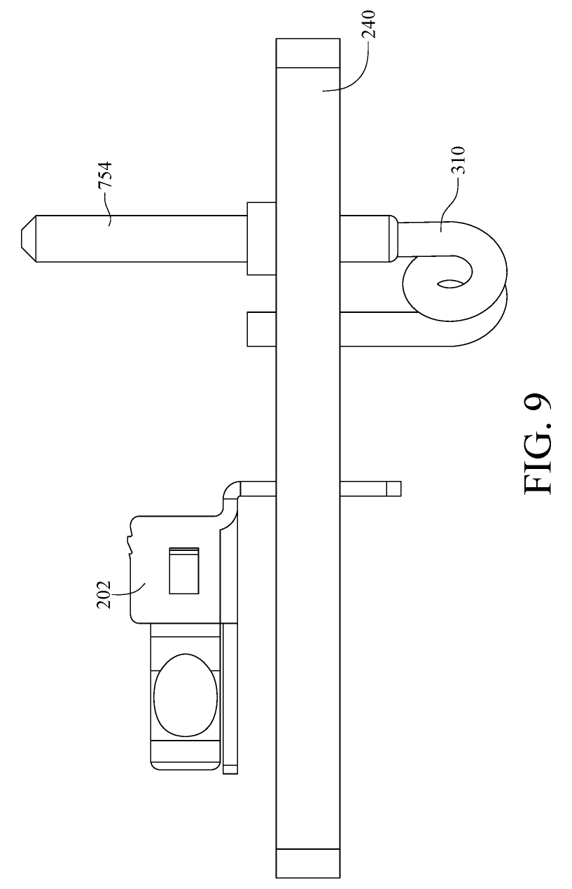

According to one embodiment, at least two of the conductor 202, the coil 310, and the pin 754 may be either integrally formed as a single piece or in direct contact with each other so as to reduce the number of the through hole 241 or the through hole 242, thereby increasing the available mounting space on the circuit board 240. In one embodiment, the conductor 202 and the coil 310 may be either integrally formed as a single piece or in direct contact with each other. In one embodiment, the conductor 202 and the pin 754 may be either integrally formed as a single piece or in direct contact with each other. In one embodiment, the coil 310 and the pin 754 may be either integrally formed as a single piece or in direct contact with each other. In one embodiment, the conductor 202, the coil 310, and the pin 754 may be either integrally formed as a single piece or in direct contact with one another. FIG. 9 is a side view of a seizure assembly according to still another embodiment of the present disclosure. In one embodiment, referring to FIG. 9, the coil 310 and the pin 754 in the seizure assembly are in direct contact with each other, but the present disclosure is not limited thereto.

According to the seizure assembly and the hybrid fiber-coaxial network device including the same disclosed in the embodiments of the present disclosure, the seizure assembly including a conductor with a leaf spring receptacle portion allows a relatively simple and consistent connection with the center conductor pin and is capable of providing the desired RF performance. The conductor is also easier to be fabricated, as compared to the set-screw spring-loaded seizure assemblies and other one-piece conductors. Further, by disposing a coil onto the seizure assembly, an excellent return loss performance, a high current flow, and high-bandwidth transmission can be achieved.

It will be apparent to those skilled in the art that various modifications and variations can be made to the disclosed embodiments. It is intended that the specification and examples be considered as exemplary only, with a true scope of the disclosure being indicated by the following claims and their equivalents.

What is claimed is:

1. A seizure assembly for a coaxial cable, the seizure assembly being configured to be coupled to the coaxial cable in a hybrid fiber-coaxial (HFC) network device and comprising:
a circuit board;
an insulator portion, coupled to the circuit board, wherein the insulator portion defines a spring receptacle passageway which is proximate to a pin-receiving opening for a center conductor pin of the coaxial cable at a side of the insulator portion;
a conductor, comprising a leaf spring receptacle portion and a mounting portion for the circuit board which are coupled to each other, wherein the leaf spring receptacle portion is disposed in the spring receptacle passageway, the leaf spring receptacle portion is configured to receive the center conductor pin passing through the pin-receiving opening, and the mounting portion is electrically coupled to the circuit board; and
a coil, electrically coupled to the circuit board.

2. The seizure assembly according to claim 1, further comprising a pin, wherein the pin extends from the circuit board and is configured to mate with a coaxial RF connector in the HFC network device, and the pin is electrically coupled to the conductor through the circuit board.

3. The seizure assembly according to claim 1, wherein the leaf spring receptacle portion is formed by a pair of leaf spring members, and the pair of leaf spring members are spaced apart from each other to receive the center conductor pin and apply a force to the center conductor pin.

4. The seizure assembly according to claim 1, wherein the conductor is stamped from a single piece of metal.

5. The seizure assembly according to claim 1, wherein the coil is a solenoidal coil formed by winding a wire.

6. The seizure assembly according to claim 1, wherein the conductor is coupled to a side of the circuit board and the coil is coupled to an opposite side of the circuit board.

7. The seizure assembly according to claim 1, wherein opposite ends of the coil are disposed into two first through holes formed by the circuit board, respectively, and the mounting portion extends into a second through hole formed by the circuit board.

8. A hybrid fiber-coaxial (HFC) network device, comprising:
a housing, comprising a coaxial cable port configured to couple to a coaxial cable external to the housing;
a seizure assembly for the coaxial cable, disposed in the housing, wherein a center conductor pin of the coaxial cable extends through the coaxial cable port and extends into the seizure assembly, and the seizure assembly comprises:
a circuit board;
an insulator portion, coupled to the circuit board, wherein the insulator portion defines a spring receptacle passageway which is proximate to a pin-receiving opening for the center conductor pin of the coaxial cable at a side of the insulator portion;
a conductor, comprising a leaf spring receptacle portion and a mounting portion for the circuit board which are coupled to each other, wherein the leaf spring receptacle portion is disposed in the spring receptacle passageway, the leaf spring receptacle portion is configured to receive the center conductor pin passing through the pin-receiving opening, and the mounting portion is electrically coupled to the circuit board;
a coil, electrically coupled to the circuit board; and
a pin, wherein the pin extends from the circuit board and is electrically coupled to the conductor through the circuit board; and
a coaxial RF connector, electrically coupled to the pin.

9. The HFC network device according to claim 8, wherein the pin is coupled to a side of the circuit board, and the insulator portion and the conductor are coupled to an opposite side of the circuit board.

10. The HFC network device according to claim 8, wherein the leaf spring receptacle portion is formed by a pair of leaf spring members, and the pair of leaf spring members are spaced apart from each other to receive the center conductor pin and apply a force to the center conductor pin.

11. The HFC network device according to claim 8, wherein the conductor is stamped from a single piece of metal.

12. The HFC network device according to claim 8, wherein the coil is a solenoidal coil formed by winding a wire.

13. The HFC network device according to claim 8, wherein opposite ends of the coil are disposed into two first through holes formed by the circuit board, respectively, and the mounting portion extends into a second through hole formed by the circuit board.

14. The HFC network device according to claim 8, wherein at least two of the conductor, the coil, and the pin are either integrally formed as a single piece or in direct contact with each other.

15. The HFC network device according to claim 8, wherein the HFC network device is configured to emit signals at frequencies up to at least 1.8 GHz.
